(19) United States
(12) Patent Application Publication
(10) Pub. No.: US 2009/0287943 A1
(43) Pub. Date: Nov. 19, 2009

(54) Mapping power domains in a data center

(75) Inventors: Thomas M. Brey, Cary, NC (US); Nickolas J. Gruendler, Raleigh, NC (US); Richard E. Harper, Chapel Hill, NC (US); William J. Piazza, Holly Springs, NC (US); Lisa F. Spainhower, Highland, NY (US)

Correspondence Address: IBM (RPS-BLF);c/o BIGGERS & OHANIAN, LLP, P.O. BOX 1469, AUSTIN, TX, 78767-1469, US

(73) Assignee: International Business Machines Corporation, Armonk, NY (US)

(21) Appl. No.: 12/121,198

(22) Filed: May 15, 2008

(51) Int. Cl. G06F 1/26

(52) U.S. Cl. 713/300

(57) ABSTRACT

Mapping power domains in a data center, the data center including one or more power consuming computing devices, the computing devices managed by a management module, each power domain in the data center including one or more power service modules located in an electrical path connecting one or more of the computing devices to a power source, each power service module associated with a power line communications controller, where the mapping includes establishing a unique domain identification for each electrical path connecting one or more of the computing devices to a power source; receiving, by the management module from the computing devices, the unique domain identifications; and maintaining, by the management module, a map associating the unique domain identifications with identifications of the computing devices.

### BACKGROUND OF THE INVENTION

1. Field of the Invention

The field of the invention is data processing, or, more specifically, methods, apparatus, and products for mapping power domains in a data center.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Today large numbers of computer systems are often grouped physically or logically in a data center to provide multiple services. Each computer system in such a data center requires power from a power source to operate. Devices that provide power oriented services are also often connected in a data center to such computer systems. Managing power, computer systems, and devices that provide power oriented services in a data center is currently a difficult, inefficient, time-consuming, and expensive task to carry out.

### SUMMARY OF THE INVENTION

Methods, apparatus, and products for mapping power domains in a data center, the data center including one or more power consuming computing devices, the computing devices managed by a management module, each power domain in the data center including one or more power service modules located in an electrical path connecting one or more of the computing devices to a power source, each power service module associated with a power line communications controller, where mapping power domains in a data center includes establishing a unique domain identification for each electrical path connecting one or more of the computing devices to a power source including: injecting into the electrical path, by each power line communications controller in the electrical path, an identification of the power service module associated with the power line communications controller, and creating a unique domain identification in dependence upon the injected identifications of the power service modules; receiving, by the management module from the computing devices, the unique domain identifications; and maintaining, by the management module, a map associating the unique domain identifications with identifications of the computing devices.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a functional block diagram of an exemplary system implementing power domain mapping in a data center according to embodiments of the present invention.

FIG. 2 sets forth a flow chart illustrating an exemplary method for mapping power domains in a data center according to embodiments of the present invention.

### DETAILED DESCRIPTION OF EXEMPLARY EMBODIMENTS

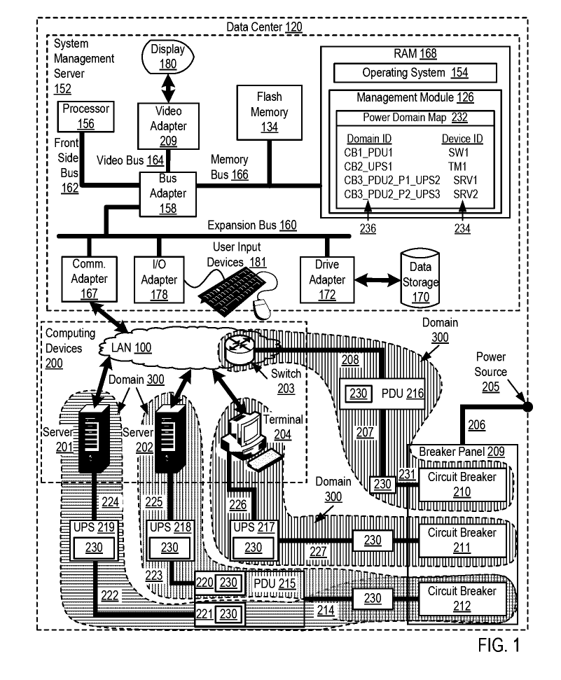

Exemplary methods, apparatus, and products for mapping power domains in a data center in accordance with the present invention are described with reference to the accompanying drawings, beginning with FIG. 1. FIG. 1 sets forth a functional block diagram of an exemplary system implementing power domain mapping in a data center (120) according to embodiments of the present invention. The data center (120) is a facility used to house mission critical computer systems and associated components. Such a data center includes environmental controls (air conditioning, fire suppression, etc.), redundant/backup power supplies, redundant data communications connections, and high security, highlighted by biometric access controls to compartmentalized security zones within the facility. A data center is also used for housing a large amount of electronic equipment, typically computers and communications equipment. A data center is maintained by an organization for the purpose of handling the data necessary for its operations. A bank, for example, may have a data center, where all its customers' account information is maintained and transactions involving these accounts are carried out. Practically every company that is mid-sized or larger has some kind of data center with the larger companies often having dozens of data centers.

The data center (120) in the example of FIG. 1 includes one or more power consuming computing devices (200), that is, automated computing machinery requiring electrical power to operate. Examples of computing devices depicted in the system of FIG. 1 include server (201), server (202), terminal (204), and data communications switch (203). The servers (201, 202) and terminal (204) are connected for data communications to a system management server (152) through a local area network (‘LAN’) (100). The LAN (100) is an aggregation of data communications switches, routers, cables, software, and so on, capable of connecting computing devices for data communications.

A server, as the term is used in this specification, refers generally to a multi-user computer that provides a service (e.g. database access, file transfer, remote access) or resources (e.g. file space) over a network connection. The term ‘server,’ as context requires, refers inclusively to the server's computer hardware as well as any server application software or operating system software running on the server. A server application is an application program that accepts connections in order to service requests from users by sending back responses. A server application can run on the same computer as the client application using it, or a server application can accept connections through a computer network. Examples of server applications include file server, database server, backup server, print server, mail server, web server, FTP servers, application servers, VPN servers, DHCP servers, DNS servers, WINS servers, logon servers, security servers, domain controllers, backup domain controllers, proxy servers, firewalls, and so on.

The system of FIG. 1 operates generally to map power domains in a data center in accordance with the present invention. In the system of FIG. 1, each power domain (300) in the data center (120) includes one or more power service modules located in an electrical path connecting one or more of the computing devices (200) to a power source (205). A power service module is any device that provides a service with respect to electrical power received by and transmitted through the device. Examples of power service modules include circuit breakers (210, 211, 212) that provide protection against a short or overloaded circuit to a computing device connected to the breaker, uninterruptible power supplies (217, 218, 219) that provide battery backup services to a computer device in case of an upstream power failure, power distribution units that distribute power to one or more computing devices, and so on as will occur to those of skill in the art. Each power service module in the example of FIG. 1 is associated with a power line communications controller (230). A power line communications controller is an aggregation of computer hardware and software capable of providing data communications on a power line. Examples of such power line communications controllers include X10™ devices, INSTEON™ devices, HomePlug™ devices, Universal Powerline Bus (‘UPB’) devices, and so on as will occur to those of skill in the art. The computing devices in the example of FIG. 1 are also capable of power line communications and although not depicted in the example of FIG. 1, may also be associated with a power line communications controller.

As mentioned above each of the power services modules in the system of FIG. 1 is associated with a power line communications controller (230). The term ‘associated’ as used in this specification when referring to a power line communications controller and power service module defines a pair of physically connected and logically linked power line communications controller and power service module. Such a pair is logically linked in that, from the point of view of downstream devices, data communications originating from the power line communications controller also originate from its associated power services module. That is, the pair operates for data communications purposes as a single device, similar by analogy to an external disk drive connected to a computer system where such combination of external hard disk drive operates from the perspective of a user in a fashion no different than that of a computer system having an internal hard disk drive. Power line communications controllers (230) in accordance with embodiments of the present invention may be physically implemented as part of the power service module itself or external to the power service module. A power line communications controller implemented external to a power service module may be associated with the power service module by being the only device directly connected to a power line originating from the power services module. Examples of such associated power services module and power line communications controller in the system of FIG. 1 include the following pairs: circuit breaker (210) and its associated power line communications controller (230); circuit breaker (211) and its associated power line communications controller (230); and circuit breaker (212) and its associated power line communications controller (230).

As mentioned above, each power domain (300) in the data center (120) of FIG. 1 includes one or more power service modules located in an electrical path connecting one or more of the computing devices (200) to a power source (205). Depicted in the example of FIG. 1 are four power domains (300), each domain powered by a power source (205). One example domain (300) includes the circuit breaker (210) connected through a power line (231) and a power line communications controller (230) to the power distribution unit (216) which includes a power line communications controller and is, in turn, connected to the data communications switch (203) through power line (208). Another example domain (300) in the system of FIG. 1 includes the circuit breaker (211) connected through a power line (227) and a power line communications controller (230) to the uninterruptible power supply (‘UPS’) (217) which includes a power line communications controller and is, in turn, connected to the terminal (204) through power line (226).

Two power domains according to embodiments of the present invention may each include the same power service modules, communication controllers, power lines, and so on. That is, two power domains may overlap. In the system of FIG. 1, two domains (300) overlap and include the circuit breaker (212) connected through a power line (214) and a power line communications controller (230) to the power distribution unit (215). One domain then includes server (202) connected through power line (225) to UPS (218), which is in turn connected through power line (223) to port (220) of the PDU (215). The other overlapping domain includes server (201) connected through power line (224) to UPS (219) which is in turn connected through power line (222) to port (221) of the PDU (215). Each port (220, 221) of the PDU (215) in the system of FIG. 1 includes a power line communications controller (230).

The system of FIG. 1 operates generally to map power domains (300) in a data center (120) by establishing a unique domain identification for each electrical path connecting one or more of the computing devices to a power source; receiving, by the management module from the computing devices, the unique domain identifications; and maintaining, by the management module, a map associating the unique domain identifications with identifications of the computing devices.

In the system of FIG. 1, establishing a unique domain identification for each electrical path connecting one or more of the computing devices (200) to a power source (205) may be carried out by injecting into the electrical path, by each power line communications controller (230) in the electrical path, an identification of the power service module associated with the power line communications controller, and creating a unique domain identification (236) in dependence upon the injected identifications of the power service modules. A power line communications controller (230) may inject an identification of the power service module into the electrical path according to a power line communications protocol, such as the HomePlug, Insteon, or X10 protocol. A power line communications controller (230) may, for example, inject an identification into an electrical path by adding to the typical AC electrical signal transmitted through a power line to include, a high-frequency carrier signal that carries the identification.

In the system of FIG. 1, creating a unique domain identification (236) in dependence upon the injected identifications of the power service modules may include concatenating, in order of location in the electrical path, the injected identifications of the power service modules. A unique domain identification that includes individual power service module identifications concatenated in order of their location in an electrical path may be parsed by a management module to identify physical connections between the devices in the power domain. Consider as an example, the power domain (300) that includes the server (201) in the system of FIG. 1. The communications controller associated with the circuit breaker (212) may inject into the power line (214) an identification of the circuit breaker (212), ‘CB3.’ Upon receiving the identification ‘CB3’ by the communications controller (230) of the PDU (215) through the power line (214), the communications controller (230) may concatenate to ‘CB3’ the identification of its associated PDU and port of the PDU, ‘PDU2P2’ and inject the concatenated identification ‘CB3_PDU2P2’ into the power line (222). Upon receiving the concatenated identification through the power line (222), the communications controller (230) associated with the UPS (219) may concatenate to ‘CB3_PDU2_P2’ the identification of the UPS (219) and inject the newly concatenated identification, ‘CB3_PDU2_P2_UPS3’ into the power line (224) for transmission to the server (201). The unique domain identification, then, of the power domain (300) that includes server (201) in this example, is ‘CB3_PDU2_P2_UPS3,’ which both uniquely identifies the power domain and each piece of equipment included in the power domain (300). Such a unique identification may be parsed by a management module to determine that the server (201) is physically connected to the UPS (219) which is physically connected to the second port of the PDU (215) which connected to the circuit breaker (212).

Injecting into the electrical path an identification of the power service module associated with the power line communications controller may also include injecting into the electrical path an identification of the power service module associated with the power line communications controller periodically upon a predefined interval of time. From time to time computing devices, power service modules and so on may be removed from a power domain (300) in the data center (120) or added to a power domain (300) in the data center (120). By injecting the identification of the power service modules in a power domain periodically, changes in the power domains may be identified and a current, or semi-current, map of the power domains may be maintained.

Injecting into the electrical path an identification of the power service module associated with the power line communications controller may also include injecting into the electrical path information describing performance of the power service module associated with the power line communications controller. Performance information of a power service module is any information that describes operating characteristics, theoretical or actual, of a power service module. A power line communications controller of a UPS (217, 218, 219), for example, may inject its status, whether operating on battery backup, its maximum power rating, the amount of power currently being used, a number of ports, or any other operating characteristic of the UPS.

The system of FIG. 1 also includes an exemplary system management server (152) useful in mapping power domains in a data center according to embodiments of the present invention. The system management server (152) is a server of the data center (120) that automates many of the processes that are required to proactively manage servers in the data center, including capacity planning, asset tracking, preventive maintenance, diagnostic monitoring, troubleshooting, firmware updates, and so on. The system management server (152) of FIG. 1 includes at least one computer processor (156) or ‘CPU’ as well as random access memory (168) (‘RAM’) which is connected through a high speed memory bus (166) and bus adapter (158) to processor (156) and to other components of the system management server (152).

Stored in RAM (168) is a management module (126), a set of computer program instructions that operate the system management server (152) so as to automatically under program control carry out processes required to manage computing devices in the data center, including capacity planning, asset tracking, preventive maintenance, diagnostic monitoring, troubleshooting, firmware updates, and so on. The management module (126) also includes computer program instructions capable of receiving, from the computing devices (200), unique domain identifications; and maintaining a map (232) associating the unique domain identifications (236) with identifications (234) of the computing devices (200).

The management module (232) may receive, from the computing devices (200), unique domain identifications (236) through the LAN (100). That is, instead of receiving the identifications (236) through an out-band data communications link, such as the power lines through which computing devices (200) receive identifications, the management module (126) may receive the identifications (236) through an in-band data communications link, the network (100). This may be useful in many data centers as the system management server (152) executing the management module (126) may be physically located remotely with respect to the power domains and as such may not be physically connected via the electrical paths of the power domains (300).

Maintaining a map of the unique domain identifications (236) may include maintaining a data structure (232) including one or more records where each record includes an association of a unique domain identification (236) and an identification of a computing device (234). Each of the records also represents a power domain (300) in the data center (120). In the example of FIG. 1, the power domain map (232) maintained by the management module (126) is implemented as a table. A table is only example of a data structure that may be used to store associations of domain identifications (236) and computing devices identifications (234). Readers of skill in the art will immediately recognize that other data structures may be useful for storing such associations including, for example, linked lists, arrays, and so on.

In addition to including a unique domain identification and a computing device identification, each record of the power domain map (232) may also include a power rating for each power domain. Such a power rating represents power capabilities of the power domain and may be used by the management module in determining workload for each computing device in the power domains, determining a system maintenance schedule for removing power from power domains, determining whether to add or remove computing devices from one or more power domains, and so on as will occur to those of skill in the art. Such a power rating may be entered by a system administrator manually or may be derived from performance information obtained from power line communications controllers in the power domains as described above.

Also stored in RAM (168) is an operating system (154). Operating systems useful for mapping power domains in a data center according to embodiments of the present invention include UNIX™, Linux™, Microsoft XP™, Microsoft Vista™, AIX™, IBM's i5/OS™, and others as will occur to those of skill in the art. The operating system (154), the management module (126), and the power domain map (232) in the example of FIG. 1 are shown in RAM (168), but many components of such software typically are stored in non-volatile memory also, such as, for example, on a disk drive (170) or in flash memory (134).

The system management server (152) of FIG. 1 includes disk drive adapter (172) coupled through expansion bus (160) and bus adapter (158) to processor (156) and other components of the system management server (152). Disk drive adapter (172) connects non-volatile data storage to the system management server (152) in the form of disk drive (170). Disk drive adapters useful in system management servers for mapping power domains in a data center according to embodiments of the present invention include Integrated Drive Electronics (‘IDE’) adapters, Small Computer System Interface (‘SCSI’) adapters, and others as will occur to those of skill in the art. Non-volatile computer memory also may be implemented as an optical disk drive, electrically erasable programmable read-only memory (so-called ‘EEPROM’ or ‘Flash’ memory) (134), RAM drives, and so on, as will occur to those of skill in the art.

The example system management server (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example system management server (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary system management server (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for mapping power domains in a data center according to embodiments of the present invention include modems for wired dial-up communications, Ethernet (IEEE 802.3) adapters for wired data communications network communications, and 802.11 adapters for wireless data communications network communications.

The arrangement of servers, terminals, switches, communications controllers, and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

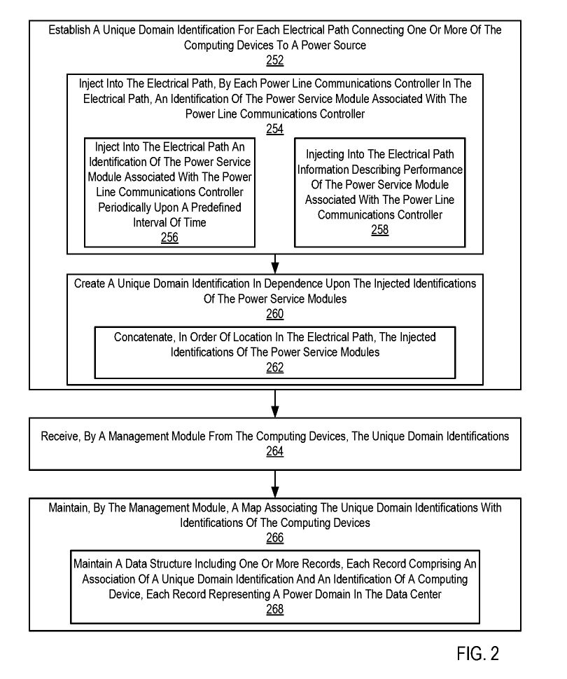

For further explanation, FIG. 2 sets forth a flow chart illustrating an exemplary method for mapping power domains in a data center according to embodiments of the present invention. The data center of FIG. 2 includes one or more power consuming computing devices (200 on FIG. 1). The computing devices (200 on FIG. 1) are managed by a management module (126 on FIG. 1). In the method of FIG. 2, each power domain (300 on FIG. 1) in the data center (120 on FIG. 1) includes one or more power service modules located in an electrical path connecting one or more of the computing devices (200 on FIG. 1) to a power source (205 on FIG. 1). In the method of FIG. 2, each power service module is associated with a power line communications controller (230 on FIG. 1).

The method of FIG. 2 includes establishing (252) a unique domain identification for each electrical path connecting one or more of the computing devices to a power source. In the method of FIG. 2, establishing (252) a unique domain identification for each electrical path connecting one or more of the computing devices to a power source includes injecting (254) into the electrical path, by each power line communications controller in the electrical path, an identification of the power service module associated with the power line communications controller, and creating (260) a unique domain identification in dependence upon the injected identifications of the power service modules.

In the method of FIG. 2, injecting (254) into the electrical path, by each power line communications controller in the electrical path, an identification of the power service module associated with the power line communications controller may include injecting (256) into the electrical path an identification of the power service module associated with the power line communications controller periodically upon a predefined interval of time. Injecting (254) into the electrical path, by each power line communications controller in the electrical path, an identification of the power service module associated with the power line communications controller may also include injecting (258) into the electrical path information describing performance of the power service module associated with the power line communications controller.

In the method of FIG. 2, creating (260) a unique domain identification in dependence upon the injected identifications of the power service modules may be carried out by concatenating (262), in order of location in the electrical path, the injected identifications of the power service modules.

The method of FIG. 2 also includes receiving (264), by a management module from the computing devices, the unique domain identifications; and maintaining (266), by the management module, a map associating the unique domain identifications with identifications of the computing devices. In the method of FIG. 2, maintaining (266), by the management module, a map associating the unique domain identifications with identifications of the computing devices may be carried out by maintaining a map of the unique domain identifications further comprises maintaining (268) a data structure including one or more records, each record comprising an association of a unique domain identification and an identification of a computing device, each record representing a power domain in the data center. Each record in the map may also include a power rating for a power domain, the power rating representing power capabilities of the power domain.

Exemplary embodiments of the present invention are described largely in the context of a fully functional computer system for mapping power domains in a data center. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of mapping power domains in a data center,
the data center comprising one or more power consuming computing devices, the computing devices managed by a management module, each power domain in the data center comprising one or more power service modules located in an electrical path connecting one or more of the computing devices to a power source, each power service module associated with a power line communications controller,
establishing a unique domain identification for each electrical path connecting one or more of the computing devices to a power source including:
injecting into the electrical path, by each power line communications controller in the electrical path, an identification of the power service module associated with the power line communications controller, and
creating a unique domain identification in dependence upon the injected identifications of the power service modules;
receiving, by the management module from the computing devices, the unique domain identifications; and
maintaining, by the management module, a map associating the unique domain identifications with identifications of the computing devices.

2. The method of claim 1 wherein maintaining a map of the unique domain identifications further comprises maintaining a data structure including one or more records, each record comprising an association of a unique domain identification and an identification of a computing device, each record representing a power domain in the data center.

3. The method of claim 2 wherein each record further comprises a power rating for a power domain, the power rating representing power capabilities of the power domain.

4. The method of claim 1 wherein creating a unique domain identification in dependence upon the injected identifications of the power service modules further comprises:
concatenating, in order of location in the electrical path, the injected identifications of the power service modules.

5. The method of claim 1 wherein injecting into the electrical path an identification of the power service module associated with the power line communications controller further comprises:
injecting into the electrical path an identification of the power service module associated with the power line communications controller periodically upon a predefined interval of time.

6. The method of claim 1 wherein injecting into the electrical path an identification of the power service module associated with the power line communications controller further comprises:
injecting into the electrical path information describing performance of the power service module associated with the power line communications controller.

7. An apparatus for mapping power domains in a data center, the data center comprising one or more power consuming computing devices, the computing devices managed by a management module, each power domain in the data center comprising one or more power service modules located in an electrical path connecting one or more of the computing devices to a power source, each power service module associated with a power line communications controller, the apparatus comprising a computer processor, a computer memory operatively coupled to the computer processor, the computer memory having disposed within it computer program instructions capable of:
establishing a unique domain identification for each electrical path connecting one or more of the computing devices to a power source including:
injecting into the electrical path, by each power line communications controller in the electrical path, an identification of the power service module associated with the power line communications controller, and
creating a unique domain identification in dependence upon the injected identifications of the power service modules;
receiving, by the management module from the computing devices, the unique domain identifications; and
maintaining, by the management module, a map associating the unique domain identifications with identifications of the computing devices.

8. The apparatus of claim 7 wherein maintaining a map of the unique domain identifications further comprises maintaining a data structure including one or more records, each record comprising an association of a unique domain identification and an identification of a computing device, each record representing a power domain in the data center.

9. The apparatus of claim 8 wherein each record further comprises a power rating for a power domain, the power rating representing power capabilities of the power domain.

10. The apparatus of claim 7 wherein creating a unique domain identification in dependence upon the injected identifications of the power service modules further comprises:
concatenating, in order of location in the electrical path, the injected identifications of the power service modules.

11. The apparatus of claim 7 wherein injecting into the electrical path an identification of the power service module associated with the power line communications controller further comprises:
injecting into the electrical path an identification of the power service module associated with the power line communications controller periodically upon a predefined interval of time.

12. The apparatus of claim 7 wherein injecting into the electrical path an identification of the power service module associated with the power line communications controller further comprises:
injecting into the electrical path information describing performance of the power service module associated with the power line communications controller.

13. A computer program product for mapping power domains in a data center, the data center comprising one or more power consuming computing devices, the computing devices managed by a management module, each power domain in the data center comprising one or more power service modules located in an electrical path connecting one or more of the computing devices to a power source, each power service module associated with a power line communications controller, the computer program product disposed in a computer readable, signal bearing medium, the computer program product comprising computer program instructions capable of:
establishing a unique domain identification for each electrical path connecting one or more of the computing devices to a power source including:
injecting into the electrical path, by each power line communications controller in the electrical path, an identification of the power service module associated with the power line communications controller, and
creating a unique domain identification in dependence upon the injected identifications of the power service modules;
receiving, by the management module from the computing devices, the unique domain identifications; and
maintaining, by the management module, a map associating the unique domain identifications with identifications of the computing devices.

14. The computer program product of claim 13 wherein maintaining a map of the unique domain identifications further comprises maintaining a data structure including one or more records, each record comprising an association of a unique domain identification and an identification of a computing device, each record representing a power domain in the data center.

15. The computer program product of claim 14 wherein each record further comprises a power rating for a power domain, the power rating representing power capabilities of the power domain.

16. The computer program product of claim 13 wherein creating a unique domain identification in dependence upon the injected identifications of the power service modules further comprises:
concatenating, in order of location in the electrical path, the injected identifications of the power service modules.

17. The computer program product of claim 13 wherein injecting into the electrical path an identification of the power service module associated with the power line communications controller further comprises:
injecting into the electrical path an identification of the power service module associated with the power line communications controller periodically upon a predefined interval of time.

18. The computer program product of claim 13 wherein injecting into the electrical path an identification of the power service module associated with the power line communications controller further comprises:
injecting into the electrical path information describing performance of the power service module associated with the power line communications controller.

19. The computer program product of claim 13 wherein the signal bearing medium comprises a recordable medium.

20. The computer program product of claim 13 wherein the signal bearing medium comprises a transmission medium.
